(19) United States
(12) Patent Application Publication
(10) Pub. No.: US 2026/0336494 A1
(43) Pub. Date: Oct. 29, 2026

(54) VEHICLE SEAT ASSEMBLY AND METHOD FOR INSTALLING TRANSDUCERS

(71) Applicant: Ford Global Technologies, LLC, Dearborn, MI (US)

(72) Inventors: Sangram Laxman Tamhankar, Farmington Hills, MI (US); Ksenia Kozak, Ann Arbor, MI (US); Megan M. Romelfanger, Grosse Pointe Woods, MI (US); Owen Li, Ann Arbor, MI (US)

(73) Assignee: Ford Global Technologies, LLC, Dearborn, MI (US)

(21) Appl. No.: 19/186,800

(22) Filed: Apr. 23, 2025

(51) Int. Cl. B60N 2/90; B60N 2/64

(52) U.S. Cl. CPC B60N 2/976; B60N 2/64

(57) ABSTRACT

A vehicle seat assembly has a seat back, a seat base and a foam cushion provided in at least one of the seat back and the seat base. The foam cushion has a first surface and a second surface and one or more pockets formed in the foam cushion. Each pocket is located proximate the first surface. One or more deformable channels extends from each of the one or more pockets to the second surface. A transducer is removably disposed in one of the one or more pockets. At least one of the one or more deformable channels are configured to deform in response to insertion or removal of the transducer from the one or more pockets through the second surface.

### FIELD OF THE DISCLOSURE

The present disclosure generally relates to vehicle seating, and more particularly relates to a vehicle seating assembly having transducers installed in the foam cushion and method of installing the same.

### BACKGROUND OF THE DISCLOSURE

Motor vehicles are commonly equipped with passenger seat assemblies which typically include a seat base and a seat back, both generally having a foam cushion. Some vehicle seat assemblies further include seat exciters having transducers located in the foam cushion for providing vibrations such as for haptic feedback and massaging functions. The transducers are typically installed in the foam cushion proximate to the front cover which is contacted by the occupant. It would be desirable to provide for a vehicle seat assembly that allows for efficient access to the transducers such as during installment and replacement.

### SUMMARY OF THE DISCLOSURE

According to a first aspect of the present disclosure, a vehicle seat assembly has a seat back, a seat base and a foam cushion provided in at least one of the seat back and the seat base. The foam cushion has a first surface and a second surface and one or more pockets formed in the foam cushion. Each pocket is located proximate the first surface. One or more deformable channels extends from each of the one or more pockets to the second surface. A transducer is removably disposed in one of the one or more pockets. At least one of the one or more deformable channels are configured to deform in response to insertion or removal of the transducer from the one or more pockets through the second surface.

Embodiments of the first aspect of the present disclosure can include any one or a combination of the following features:
a seat cushion cover covering the first surface of the foam cushion;
one or more covers are removably attached to the second surface of the foam cushion and substantially cover at least one of the one or more deformable channels;
the one or more covers comprises a high density foam material having a density greater than a density of the foam cushion;
the one or more covers are removably attached using a hook and loop fastening system;
one or more cables extend from each transducer through the one or more deformable channels;
the one or more cables are connected to a vehicle power source;
a controller is configured to receive an input and to control the one or more transducers in response to the input to provide haptic feedback to an occupant seated on the vehicle seat assembly; and
the foam cushion includes a first foam cushion provided in the seat back and a second foam cushion provided in the seat base.

According to a second aspect of the present disclosure, a vehicle seat assembly has a seat back cushion comprising a front side and a back side and a seat base cushion comprising a top side and a bottom side. One or more first pockets are formed in the seat back cushion, each first pocket located proximate the front side. One or more first deformable channels extend from the one or more first pockets of the seat back cushion to the back side. One or more second pockets are formed in the seat base cushion, each second pocket located proximate the top side. One or more second deformable channels extend from the one or more second pockets of the seat base cushion to the bottom side. A first transducer is removably disposed in one of the one or more first pockets of the seat back cushion. One of the one or more first deformable channels are configured to deform in response to insertion or removal of the first transducer from the one of the one or more first pockets through the back side. A second transducer is removably disposed in one of the one or more second pockets of the seat base cushion. One of the one or more second deformable channels are configured to deform in response to insertion or removal of the second transducer from the one of the one or more second pockets through the bottom side.

Embodiments of the second aspect of the present disclosure can include any one or a combination of the following features:
a seat back cover covering the front side of the seat back cushion and a seat base cover covering the top side of the seat base cushion;
one or more covers are removably attached to each of the back side of the seat back cushion and the bottom side of the seat base cushion, each cover substantially covering at least one of the one or more first and second deformable channels;
one or more cables extend from each of the first and second transducers through the one or more first and second deformable channels;
a controller is configured to receive an input and to control the first and second transducers in response to the input to provide haptic feedback to an occupant seated on the vehicle seat assembly, wherein the one or more cables are coupled to a vehicle power source and are in communication with the controller;
the one or more covers are removably attached using a hook and loop fastening system; and
the one or more covers comprises a high density foam material having a density greater than a density of the seat back cushion and the seat base cushion.

The present disclosure also includes a method for installing a transducer into a vehicle seat assembly. The method steps include providing a vehicle seat back and vehicle seat base, providing a foam cushion in at least one of the vehicle seat back and the vehicle seat base, forming one or more pockets in the foam cushion, wherein the one or more pockets are proximate a first side of the foam cushion, forming one or more deformable channels that extend from the one or more pockets to a second side of the foam cushion, and placing a transducer in one of the one or more pockets through the one or more deformable channels.

Embodiments of the third aspect of the present disclosure can include any one or a combination of the following steps:
feeding cables from the one or more transducer devices through the one or more deformable channels and out of the foam cushion from the second side;
removably attaching one or more covers on the second side of the foam cushion and substantially covering the one or more deformable channels with one or more covers having a high density foam material having a density higher than a density of the foam cushion; and
installing a cover on the first side of the foam cushion.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper front perspective view of a motor vehicle having a seat assembly with a plurality of transducers, according to one embodiment;

FIG. 2 is a front perspective view of the seat assembly with a rear covering and a pair of transducers removed;

FIG. 3 is a rear perspective view of the seat assembly with the rear covering and one of the transducers removed;

FIG. 4 is a cross-sectional view taken through line IV-IV of FIG. 2 illustrating a transducer in the fully assembled position;

FIG. 5 is a cross-sectional view taken through line IV-IV of FIG. 2 with the transducer in a partially assembled position; and

FIG. 6 is a cross-sectional view taken through a portion of the seat back illustrating the foam cushion pocket and channel.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

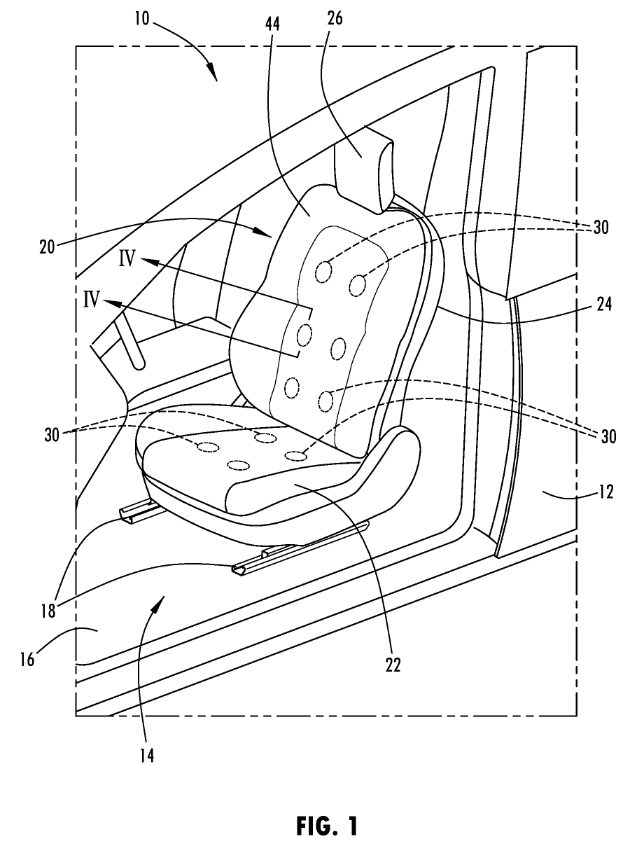

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle seat assembly having one or more transducers and a method for installing transducers into the vehicle seat assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-5, a vehicle seat assembly 20 is illustrated having a seat back 24, a seat base 22 and a foam cushion 32 provided in at least one of the seat back 24 and seat base 22, with the foam cushion 32 having a first surface 40 and a second surface 42. The vehicle seat assembly 20 has one or more pockets 34 formed in the foam cushion 32, each pocket 34 located proximate to the first surface 40. The vehicle seat assembly 20 also has one or more deformable channels 36 extending from each of the one or more pockets 34 to the second surface 42. The vehicle seat assembly 20 further includes a transducer 30 removably disposed in one of the one or more pockets 34, wherein at least one of the one or more deformable channels 36 are configured to deform in response to insertion or removal of the transducer 30 from the one or more pockets 34 through the second surface 42.

With particular reference to FIG. 1, a motor vehicle 10, such as a wheeled motor vehicle, is generally illustrated configured with passenger seating and accommodations for transporting one or more passengers. The motor vehicle 10 has a vehicle body 12 that generally defines a cabin interior 14. The cabin interior 14 may contain seating accommodations and vehicle controls and various other features and trim components within the vehicle body 12. The cabin interior 14 is shown having one or more passenger seats including a seat assembly 20 which may be configured as a Captain’s seat, for example, which may be arranged in a row of seats. The motor vehicle 10 may include a front row of two or more seats, a rear row of two or more seats and further rows of seats for large vehicles such as large sport utility vehicles (SUVs), vans and buses. It should be appreciated that the motor vehicle 10 may be a motor vehicle, such as a wheeled car, truck, SUV, van or bus, for example, or an airplane, train, boat or other vehicle capable of transporting one or more passengers.

The vehicle seat assembly 20 may be configured in the cabin interior 14 to be a driver’s seat assembly which would typically be rearward of a steering wheel assembly and a front dashboard of the motor vehicle 10, or may be a front row passenger seat assembly. The seat assembly 20 may be a second row or further rearward row seat assembly located in the motor vehicle 10 for seating one or more passengers in the motor vehicle 10.

The seat assembly 20 is generally shown assembled onto and supported by a floor 16 of the cabin interior 14 via a seat track 18 mounting arrangement. The seat assembly 20 includes a seat base 22 and an upright seat back 24 which may include a headrest 26 on the top end thereof. The seat back 24 may articulate or pivot relative to the seat base 22 between upright and reclined seating positions.

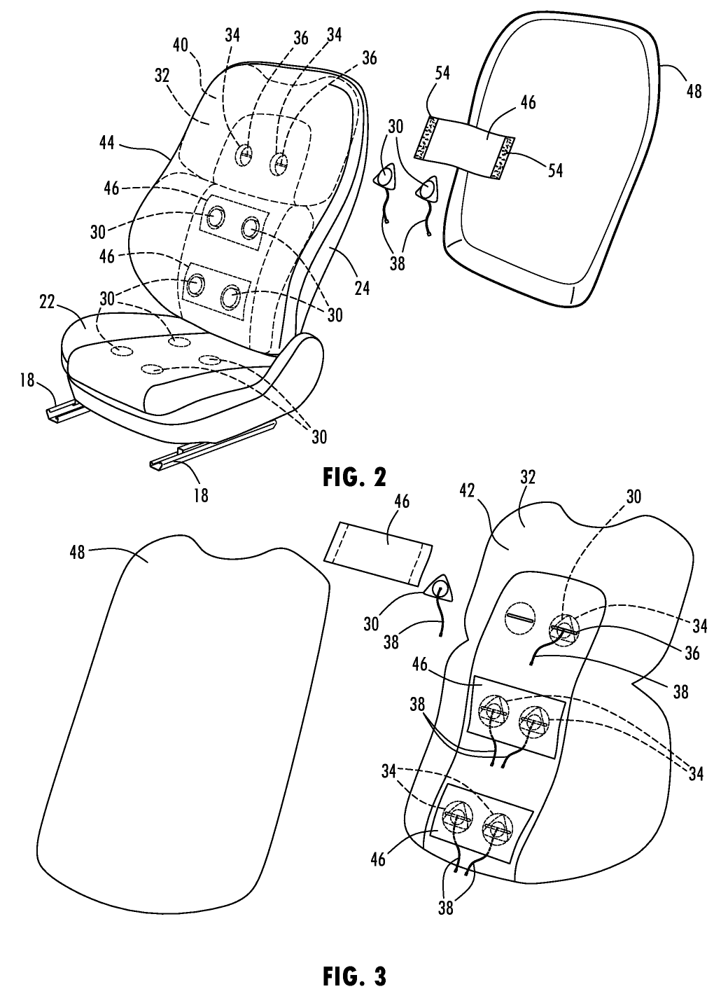

Referring also to FIG. 2, the seat back 24 of the seat assembly 20 is shown having a cushion foam 32 covered by a seat cover 44. The seat cover 44 may include leather, fabric, vinyl or other covering and may include added foam or other cushion padding. The cushion foam 32 is a low density foam that generally provides a cushioning. The seat assembly 20 is shown having a plurality of seat exciters in the form of transducers 30 located in the foam cushion 32 in the seat back 24. In the example shown, six transducers 30 are located in the seat back 24 with three rows of two transducers 30 spaced apart from one another. The seat base 22 likewise has a low density foam cushion 32 generally covered by a seat cover 44 and is shown having four transducers 30 located in the seat cushion, according to one example, with two rows of two transducers 30 spaced throughout the seat base 22.

The transducers 30 are electrically powered seat exciters that are integrated into the seat back 24 and the seat base 22 cushions to provide a tactile feel such as a haptic feedback or vibrations. The haptic feedback/vibrational feedback may be used as a sensory feedback to enhance alertness, such as driver alerts and steering wheel takeover alerts, to further enjoy music or to provide a massaging effect. The transducers 30 are electrically powered and may be controlled to activate together or may be individually controlled to provide the desired effect. For example, lane assist feedback may be provided by the transducers 30 on the left or right sides of the seat back 24 and seat base 22.

Referring to FIGS. 2-4, the foam cushion 32 provided in the seat back 24 is illustrated according to one example. The foam cushion 32 has a first surface 40 which serves as a front A-surface of the foam on the front side of the seat back 24 and further has a second surface 42 which serves as a rear B-surface of the foam on a rear side of the foam cushion 32. One or more pockets 34, also referred to as cavities, are formed in the foam cushion 32. Each pocket 34 is located proximate the first surface 40. In the example shown, six pockets 34 are formed in the front first surface 40 of the foam cushion 32. Each of the pockets 34 are formed as cavities that extend inward from the first surface 40 of the foam cushion 32 to a depth and width sufficient to hold a removable transducer 30. The pockets 34 may be circular and may have a size sufficient to hold a transducer 30.

One or more deformable channels 36 are formed extending from each of the one or more pockets 34 to the second surface 42 of the foam cushion 32. In the example shown, each pocket 34 has a deformable channel 36 such that six deformable channels 36 are shown in the seat back 24 in the example. The cushion foam 32 is a soft pliable low density foam cushion 32 that is deformable. The deformable channels 36 may be configured as narrow horizontal slots 36 having a rectangular cross-sectional shape as shown in FIG. 3 or may have a vertical or other angular orientation and other shapes. The deformable channel 36 is smaller than the pocket 34 and is sufficiently deformable to enable the insertion and removal of the removable transducer 30 from the pocket 34 through the deformable channel 36 to enable servicing or replacement of the transducer 30.

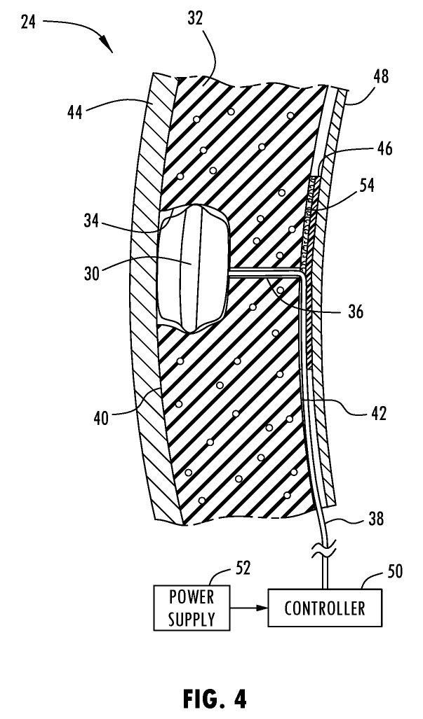

With the transducer 30 fully assembled within the pocket 34 as shown in FIG. 4, the removable transducer 30 provides a sensory haptic feedback to a seated passenger on the cover 44. In this position, the transducer 30 is located proximate the cushion cover 44 to provide a sensory coupling with a seated occupant. Each transducer 30 has a power cable 38 that may extend through the deformable channel 36 and may be coupled to a controller 50 which in turn receives electrical power from a vehicle power supply 52. The controller 50 may activate individual transducers 30 or may activate two or more or all of the transducers 30 to provide the haptic/vibrational feedback. The controller 50 may be a seat controller and may be located on the seat assembly 20 or separate from the seat assembly 20.

The seat back 24 is shown having one or more covers including a high density foam pad 46 located proximate to each pair of transducers 30 on the back side of the cushion foam 32. The high density foam pad 46 has a higher density as compared to the cushion foam 32 and is not as compressible or deformable. The high density foam pad 46 may be connected to the rear side of the cushion foam 32 via connectors 54 which, in one example, may include hook and loop connectors, such as Velcro®, for example, that may be removable to allow access to the deformable channel 36. A rear cover 48 is shown on the back side of the seat back 24 and may serve as a trim component that may be removed to allow access to the high density foam pad 46 and further to the deformable channels 36 to enable servicing of the removable transducers 30. The rear cover 48 may be polymeric trim panel, for example.

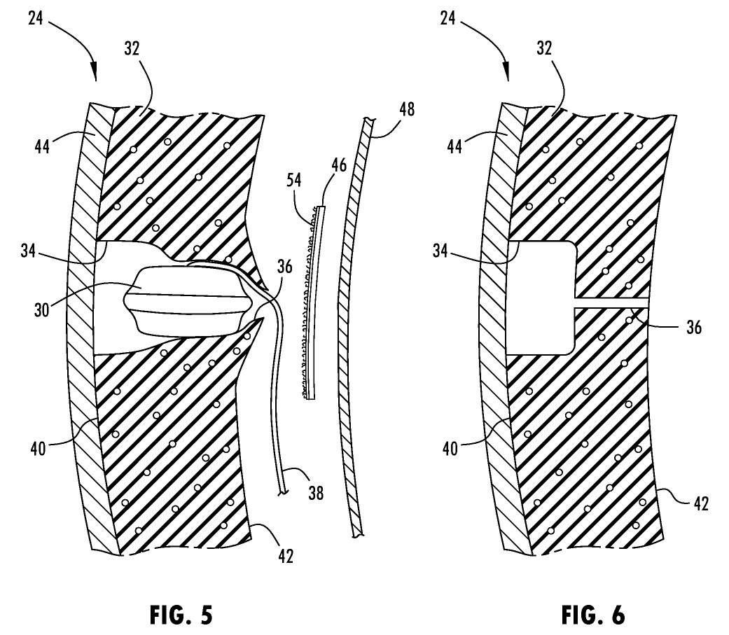

The removable transducer 30 may be assembled into or removed from the vehicle seat back 24 as shown in FIG. 5 by removing the covers including the rear cover 44 and the high density foam pad 46 to provide access to the rear side of the deformable channel 36. A removable transducer 30 may be inserted into or removed from the cushion foam 32 through the deformable channel 36 by applying force to deform the cushion foam 32 proximate the deformable channel 36 as shown in FIG. 5. As such, a user may insert or remove a removable transducer 30 through the back side of the seat back 24 without having to remove the cushion cover 44 on the front side. With the removable transducer 30 removed from the cushion foam 32 as shown in FIG. 6, the deformable channel 36 returns to its original shape due to memory.

It should be appreciated that the vehicle seat assembly 20 advantageously allows for servicing or replacement of a transducer 30 in a seat component, such as a seat back 24 shown and described herein. However, it should also be appreciated that the seat base 22 may likewise be configured to include the deformable channel 36 in a bottom side and a high density foam pad 46 covering the deformable channel 36 on the bottom side, and a further cover located below the high density foam pad 46. As such, the one or more pockets 34 and one or more deformable channels 36 and transducers 30 may be employed on either of the seat back 24 and seat base 22 and may further be employed on the headrest 26, according to further examples.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle seat assembly, comprising:
a seat back;
a seat base;
a foam cushion provided in at least one of the seat back and the seat base, the foam cushion having a first surface and a second surface;
one or more pockets formed in the foam cushion, each pocket located proximate the first surface;
one or more deformable channels extending from each of the one or more pockets to the second surface; and
a transducer removably disposed in one of the one or more pockets, wherein at least one of the one or more deformable channels are configured to deform in response to insertion or removal of the transducer from the one or more pockets through the second surface.

2. The vehicle seat assembly of claim 1, further comprising a seat cushion cover covering the first surface of the foam cushion.

3. The vehicle seat assembly of claim 1, wherein one or more covers are removably attached to the second surface of the foam cushion and substantially cover at least one of the one or more deformable channels.

4. The vehicle seat assembly of claim 3, wherein the one or more covers comprises a high density foam material having a density greater than a density of the foam cushion.

5. The vehicle seat assembly of claim 4, wherein the one or more covers are removably attached using a hook and loop fastening system.

6. The vehicle seat assembly of claim 5, wherein one or more cables extend from each transducer through the one or more deformable channels.

7. The vehicle seat assembly of claim 6, wherein the one or more cables are connected to a vehicle power source.

8. The vehicle seat assembly of claim 1, further comprising a controller configured to receive an input and to control the one or more transducers in response to the input to provide haptic feedback to an occupant seated on the vehicle seat assembly.

9. The vehicle seat assembly of claim 1, wherein the foam cushion includes a first foam cushion provided in the seat back and a second foam cushion provided in the seat base.

10. A vehicle seat assembly, comprising:
a seat back cushion comprising a front side and a back side;
a seat base cushion comprising a top side and a bottom side;
one or more first pockets formed in the seat back cushion, each first pocket located proximate the front side, wherein one or more first deformable channels extend from the one or more first pockets of the seat back cushion to the back side;
one or more second pockets formed in the seat base cushion, each second pocket located proximate the top side, wherein one or more second deformable channels extend from the one or more second pockets of the seat base cushion to the bottom side;
a first transducer removably disposed in one of the one or more first pockets of the seat back cushion, wherein one of the one or more first deformable channels are configured to deform in response to insertion or removal of the first transducer from the one of the one or more first pockets through the back side; and
a second transducer removably disposed in one of the one or more second pockets of the seat base cushion, wherein one of the one or more second deformable channels are configured to deform in response to insertion or removal of the second transducer from the one of the one or more second pockets through the bottom side.

11. The vehicle seat assembly of claim 10, further comprising a seat back cover covering the front side of the seat back cushion and a seat base cover covering the top side of the seat base cushion.

12. The vehicle seat assembly of claim 10, wherein one or more covers are removably attached to each of the back side of the seat back cushion and the bottom side of the seat base cushion, each cover substantially covering at least one of the one or more first and second deformable channels.

13. The vehicle seat assembly of claim 12, wherein one or more cables extend from each of the first and second transducers through the one or more first and second deformable channels.

14. The vehicle seat assembly of claim 13, further comprising a controller configured to receive an input and to control the first and second transducers in response to the input to provide haptic feedback to an occupant seated on the vehicle seat assembly, wherein the one or more cables are coupled to a vehicle power source and are in communication with the controller.

15. The vehicle seat assembly of claim 12, wherein the one or more covers are removably attached using a hook and loop fastening system.

16. The vehicle seat assembly of claim 15, wherein the one or more covers comprises a high density foam material having a density greater than a density of the seat back cushion and the seat base cushion.

17. A method for installing a transducer into a vehicle seat assembly, comprising:
providing a vehicle seat back and vehicle seat base;
providing a foam cushion in at least one of the vehicle seat back and the vehicle seat base;
forming one or more pockets in the foam cushion, wherein the one or more pockets are proximate a first side of the foam cushion;
forming one or more deformable channels that extend from the one or more pockets to a second side of the foam cushion; and
placing a transducer in one of the one or more pockets through the one or more deformable channels.

18. The method for installing a transducer into a vehicle seat assembly of claim 17, further comprising the step of feeding cables from the one or more transducer devices through the one or more deformable channels and out of the foam cushion from the second side.

19. The method for installing a transducer into a vehicle seat assembly of claim 17, further comprising the step of removably attaching one or more covers on the second side of the foam cushion and substantially covering the one or more deformable channels with one or more covers having a high density foam material having a density higher than a density of the foam cushion.

20. The method for installing a transducer into a vehicle seat assembly of claim 17, further comprising the step of installing a cover on the first side of the foam cushion.
